(19) United States
(12) Patent Application Publication
(10) Pub. No.: US 2023/0267244 A1
(43) Pub. Date: Aug. 24, 2023

(54) SYSTEM AND METHOD FOR MODELING CORRELATION IN A SOURCING MODEL USING SIMILARITY MATRIX DECOMPOSITION

(71) Applicant: Booz Allen Hamilton Inc., McLean, VA (US)

(72) Inventors: Robert JOYCE, Odenton, MD (US); Edward Simon Paster RAFF, Jamesville, NY (US)

(73) Assignee: Booz Allen Hamilton Inc., McLean, VA (US)

(21) Appl. No.: 17/517,241

(22) Filed: Nov. 2, 2021

(51) Int. Cl. G06F 30/20; G06F 17/16

(52) U.S. Cl. CPC G06F 30/20; G06F 17/16; G06F 2111/10

(57) ABSTRACT

Embodiments relate to a system for modeling correlation in a sourcing model. The system can include a processor configured to collect voting output from plural voting sources and store the voting output in memory. The system can include a correlation modeling module configured to retrieve at least two voting outputs from memory. In some embodiments each voting output is from a different voting source. The correlation modeling module can determine correlation among at least two voting sources by measuring consensus among the at least two voting sources using an agreement metric. The correlation modeling module can determine a degree of a first-order interaction among the at least two voting sources. The correlation modeling module can determine a degree of correlation among the at least two voting sources having a degree of first-order interaction.

### FIELD

Embodiments relate to systems and methods for determining a degree of correlation among at least two voting sources that is attributed to first-order interaction(s) among the at least two voting sources.

### BACKGROUND INFORMATION

Two chronic problems exist in the study of malware, namely malware detection (deciding whether a file is benign or malicious) and malware family classification (determining which of many existing families a malware sample might belong to). These tasks both require labeled data, but new malware samples number in the millions each month [19] and obtaining ground truth labels via manual analysis can take hours of effort per sample [24]. For this reason, the vast majority of known malware classification applications use the aggregated results from a collection of antivirus engines as a source of scalable labeling [26]. For example, a common approach to malware detection is antivirus thresholding, in which some minimum number of antivirus engines in a collection must detect a file as malicious in order for it to be considered malware [5, 8]. Likewise, plurality and majority voting among antivirus engines are popular strategies for performing malware family classification [2, 17]. A significant, but often incorrect, assumption of these aggregation approaches is that all antivirus engines’ classification results are reached by independent means so the engines are treated as independent voters, yet prior research shows that some groups of antivirus engines make highly correlated labeling decisions [9, 17, 26] due to similarity of classification methods or the re-use or dependence on the classification results of other engines. As is well attested within the machine learning (ML) literature, the use of highly correlated models provides little benefit [3, 7, 25]. The presence of strong correlations from lack of independence among some antivirus engines would likely result in degraded accuracy when these voting methods are used.

Although the existence of correlations among antivirus engines is well-documented, there has been minimal study of why they exist. Known explanations include different engines created by the same company, products “copying” the results of leading vendors, and vendors sub-licensing their technology to others [12, 17]. All of the above explanations can be considered “first-order” interactions, since they create a direct link between the labeling decisions of two antivirus engines. Yet, no existing work has empirically confirmed whether first-order interactions are the sole cause of the correlations among antivirus engines, or whether more complex, unknown factors are also (at least in part) responsible.

An additional consideration overlooked by prior research and applications is the volatile and adversarial nature of the malware ecosystem. Malware authors are constantly attempting to evade detection while antivirus engines are continually forced to develop new detection methods [13]. The inventors’ research, however, indicates that the correlation and basis for correlation of groups of antivirus engines at any point in time may change over time. Again there are is no prior research that has studied this possibility [14].

Mohaisen and Alrawi [12] is the earliest work the inventors are aware of which systematically evaluates the performance of antivirus engines. Those authors observed that the detection results of many antivirus engines follow those of a leading product and hypothesize that correlation is due to copying or sharing of information. Hurier et al. [6] introduced several metrics for quantifying the level of consensus within a set of antivirus engines. The present disclosure explores how one of these metrics, synchronicity, can change over a ten-year period. Kantchelian et al. [9] observed that antivirus labels take time to stabilize and that antivirus vendors may change their detections to correct errors, especially false negatives. In a study of 734,000 executables first seen on VirusTotal (an online malware analysis service that scans files with a collection of antivirus engines) between January 2012 and June 2014, the authors measured correlation among the detections of a group of approximately 80 antivirus engines. They found that although some groups are highly correlated, antivirus engines lacked an overall consensus. Martin et al. [11] surveyed a dataset of 82,866 suspicious Android applications and showed that some antivirus engines also make correlated decisions when labeling malware as a particular category or family. Zhu et al. [26] re-scanned a collection of 14,000 malware samples daily for over a year in order to investigate the dynamics of antivirus detection changes. By observing which antivirus engines changed their detections with similar timing, those authors identified five groups of highly correlated antivirus engines. Furthermore, Zhu et al. [26] used influence modeling to identify antivirus engines which actively change their detections to match other vendors. They determined that label copying is a widespread practice in the antivirus industry. All of these works generally lead to first-order conclusions about correlation, but do not study the correlations on the same quantity of data (25 million scan reports) or length of time (ten years) that are considered by the present disclosure.

Descriptions of one or more embodiments of the present disclosure are not intended to explain how correlations among antivirus engines came to exist, but instead to answer questions about the nature of these correlations and how they change over time. The present disclosure also introduces (1) a Rank-1 Similarity Matrix decomposition (R1SM) developed by the inventors, which reveals first-order interactions between the constituents of a similarity matrix, and (2) an extension to R1SM that uses a neural network over positional embeddings to concurrently decompose a time-series of similarity matrices, which is termed herein as Temporal Rank-1 Similarity Matrix decomposition (R1SM-T). The inventors appliedR1SM and R1SM-T to over 25 million antivirus scan reports spanning a decade in order to identify first-order interactions among the constituent antivirus engines. The results indicate that relationships among antivirus engines are more mercurial than previously thought and consideration should be given to utilizing antivirus aggregation strategies that use weighted ensembles, where the weights of each antivirus engine are a function of time.

Although groups of strongly correlated antivirus engines are known to exist, at present there is limited understanding of how or why these correlations came to be. Using the above-mentioned corpus of 25 million VirusTotal reports representing over a decade of antivirus scan data, the inventors challenge prevailing wisdom that these correlations primarily originate from “first-order” interactions such as antivirus vendors copying the labels of leading vendors. The inventors developed R1SM-T to investigate the origins of these correlations and to model how consensus among antivirus engines changes over time. Results revealed that first-order interactions do not explain as much behavior in antivirus correlation as previously thought, and that the relationships among antivirus engines are highly volatile.

### SUMMARY

Embodiments relate to a system for modeling correlation in a sourcing model. The system can include a processor configured to collect voting output from plural voting sources and store the voting output in memory. The system can include a correlation modeling module configured to retrieve at least two voting outputs from memory. In some embodiments, each voting output is from a different voting source. The correlation modeling module can be configured to determine the degree of correlation among at least two voting sources by measuring consensus among the at least two voting sources using an agreement metric. Based on the degree of correlation among voting sources, the correlation modeling module can be configured to determine a degree of correlation among the at least two voting sources attributed to the first-order interaction.

Embodiments can relate to a system for modeling correlation in a sourcing model. The system can include a processor configured to collect voting output from plural voting sources and store the voting output in memory. The system can include a correlation modeling module configured to retrieve at least two voting outputs from memory. In some embodiments, each voting output is from a different voting source. The correlation modeling module can be configured to determine a degree of correlation among the at least two voting sources by measuring consensus among the at least two voting sources using an agreement metric. The correlation modeling module can be configured to determine a degree of correlation among the at least two voting sources attributed to the first-order interaction. The processor can be configured to assign a weight factor to each voting source of the at least two voting sources based on the degree of correlation attributed to the first-order interaction.

Embodiments can relate to a method for modeling correlation in a sourcing model. The method can involve retrieving at least one voting output. This can involve retrieving at least one voting output from each of at least two different voting sources. The method can involve determining correlation among the at least two voting sources by measuring consensus among the at least two voting sources using an agreement metric. The method can involve determining a degree of correlation among the at least two voting sources attributed to the first-order interaction.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Other features and advantages of the present disclosure will become more apparent upon reading the following detailed description in conjunction with the accompanying drawings, wherein like elements are designated by like numerals, and wherein:

FIG. 1 shows an exemplary system configuration for modeling correlation in a sourcing model;

FIG. 2 shows a distribution of scan count by scan dates in VirusShare-VT;

FIGS. 3A and 3B show similarity matrices displaying pairwise detection and classification, FIG. 3A being a detection matrix and FIG. 3B being a classification matrix;

FIG. 4 shows monthly detection and classification synchronicity among antivirus engines in VirusShare-VT;

FIG. 5 shows R1SM decomposition of a detection agreement similarity matrix for VirusShare-VT;

FIG. 6 shows clusters extracted from a R1SM decomposition of a detection percent agreement matrix (δ = 0.1%, ∈ = 0.85);

FIG. 7 shows R1SM decomposition of an antivirus classification agreement similarity matrix;

FIG. 8 shows clusters extracted from a R1SM decomposition of a classification percent agreement matrix (δ = 0.1%, ∈ = 0.7);

FIG. 9 shows monthly detection and classification synchronicity explained by R1SM-T;

FIG. 10 shows first components for time-series of similarity matrices measuring monthly antivirus detection percent agreement in VirusShare-VT; and

FIG. 11 shows first components for time-series measuring antivirus classification percent agreement in VirusShare-VT.

### DETAILED DESCRIPTION

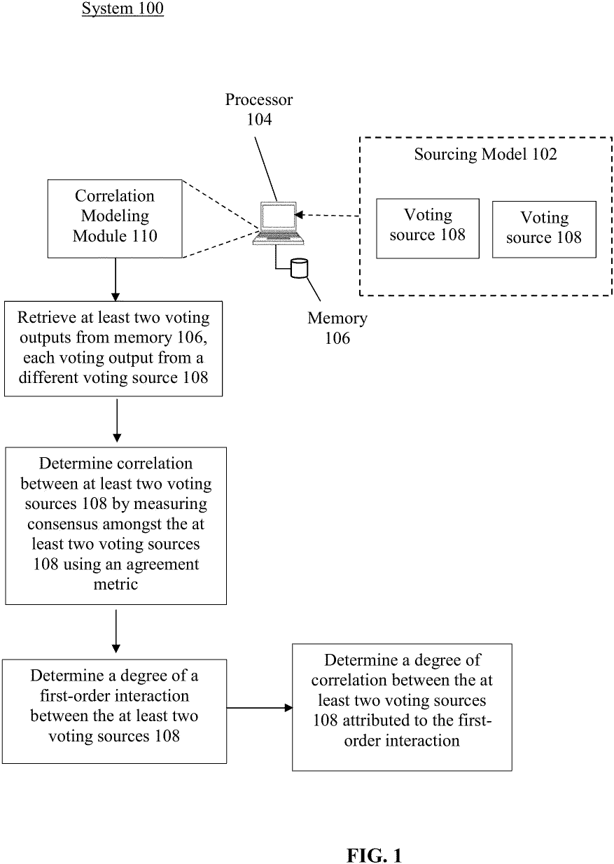

Referring to FIG. 1, embodiments relate to a system 100 for modeling correlation in a sourcing model 102. The system 100 can include a processor 104 or a processing module. This disclosure may reference one or more processors 104 on one or more processing modules. Any of the processing modules discussed herein can include a processor 104 and associated memory 106. A processing module can be embodied as software and stored in memory 106, the memory 106 being operatively associated with the processor 104. A processing module can be a software or firmware operating module configured to implement any of the method steps disclosed herein. A processing module can be embodied as a web application, a desktop application, a console application, etc. Any of the processors 104 discussed herein can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. It should be noted that use of processors 104 herein includes Graphics Processing Units (GPUs), Field Programmable Gate Arrays (FPGAs), Central Processing Units (CPUs), etc. Any of the memory 106 discussed herein can be computer readable memory configured to store data. The memory 106 can include a volatile or non-volatile, transitory or non-transitory memory (e.g., as a Random Access Memory (RAM)), and be embodied as an in-memory, an active memory, a cloud memory, etc. Embodiments of the memory 106 can include a processor module and other circuitry to allow for the transfer of data to and from the memory 106, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, optoelectronic-based, quantum-based, etc.

The processor 104 can be configured to collect voting output from plural voting sources 108 and store the voting output in memory 106. As noted herein, embodiments of the system 100 are directed toward modeling correlation in a sourcing model 102. The sourcing model 102 can be a model in which voting sources 108 generate voting output. A voting source 108 can be a device, a system, an intelligent agent of an artificial intelligence system, a human, etc. that generates a decisioning output based on inputs provided to it. The decisioning output is a voting output. Plural voting sources 108 can form a sourcing model 102. The sourcing model 102 can be designed to study the decisioning of the voting outputs from each individual voting source 108 or any combination of voting sources 108, designed to use the voting outputs of any one or combination of voting sources 108 to provide an analytical result, etc. The processor 104 collects voting output from any one or combination of voting sources 108 of the sourcing model 102. The processor 104 stores the voting output in memory 106 for data manipulation, processing, acquisitioning. etc.

As a non-limiting example, the sourcing model 102 can be plural anti-virus software engines, wherein each anti-virus engine is a voting source 108. The sourcing model 102 can be used to assist with malware detection and anti-virus labeling for a computer system, for example. For instance, a computer system can be a computer network of an entity (e.g., corporation, government agency, etc.). The sourcing model 102 can be anti-virus engine-1 and anti-virus engine-2 operating on the computer system for detecting and labeling. Anti-virus engine-1 can generate voting output-1 regarding detection and labeling, and anti-virus engine-2 can generate voting output-2 regarding detection and labeling. Voting output-1 and voting output-2 can be compared, analyzed, weighed, used to validate each other, etc. to ascertain whether an attack occurred, determine whether labeling is proper or accurate, determine a degree or probability that the two engines are detecting and labeling the same attack, etc.

The system 100 can include a correlation modeling module 110. The correlation modeling module 110 can be a processor 104 or a processing module. The correlation modeling module 110 can be configured to retrieve at least two voting outputs from memory 106. As noted herein, one of the goals of the system 100 is to model correlation within the sourcing model 102. Thus, it is contemplated for voting output retrieved from the memory 106 to be voting output from different voting sources 108. For instance, the plural voting sources 108 may include a first voting source 108 (generating first voting output), a second voting source 108 (generating second voting output), and a third voting source 108 (generating third voting output). The correlation modeling module 110 can retrieve voting output from memory 106 that comprises first voting output and second voting output, or first voting output and third voting output, or second voting output and third voting output. The voting output can be from any number or combination of voting sources 108 of the plural voting sources 108, provided that at least two voting outputs are from two different voting sources 108. In addition, depending on the type of analysis being performed, the voting output from a first voting source 108 may or may not contain the same number of votes as that from the second voting source 108. The reason for retrieving voting output from different voting sources 108 is because the correlation modeling module 110 will model correlation between the voting sources 108. Correlation, as used herein, is a measure or factor of how voting output from a first voting source 108 coincides or corresponds with voting output from a second voting source 108. This can provide insight and analytic metrics as to if, and to what extent, a mutual relationship or connection the first voting source 108 has with the second voting source 108.

For instance, anti-virus engine-1 may be generating voting output-1 that is similar or the same as voting output-2 from anti-virus engine-2. The fact that the outputs are similar or the same is not necessarily of concern and is not being measured, but rather why they are similar or the same is being measured. Determining the correlation is the first step in this process. If the two voting sources 108 are acting independently or in a non-correlated manner to generate a same or similar result, then this may not be too much of a concern. However, if the two voting sources 108 are acting in a dependent or correlated manner to generate a same or similar result, then this is a concern, and this is what is being detected by the inventive methods disclosed herein. An exemplary reason for two anti-virus engines acting in a correlated manner is that the labels for labeling used by both anti-virus engines are the same (e.g., developers of one anti-virus engine copies labels from the other anti-virus engine).

As another example, suppose the sourcing model 102 comprises students as voting sources 108. If student-1 is cheating from student-2, correlation would be detected in their voting output (their answers on a test).

The type of interactions discussed above that lead to the correlated behavior of voting sources 108 can be referred to as first-order interactions. A first-order interaction can be defined as an effect in which a pattern of values on one variable changes depending on the combination of values on two other variables.

The correlation modeling module 110 can be configured to determine correlation among at least two voting sources 108 by measuring consensus among the at least two voting sources 108 using an agreement metric. Consensus is a measure of how voting sources 108 generate the same or similar voting output over a period of time. The agreement metric is an algorithmic step performed by the correlation modeling module 110 based on the voting output of the voting sources 108. With the agreement metric, the correlation modeling module 110 can be configured to determine a degree of a first-order interaction among the at least two voting sources 108. The correlation modeling module 110 can be configured to determine a degree of correlation among the at least two voting sources 108 attributed to the first-order interaction.

The present disclosure provides an overview of the correlation modeling process and operational aspects of components of the system 100. Details of the process steps will be discussed later when applying the correlation modeling process in exemplary implementations. Thus, details of the consensus measure, development of the agreement metric, and how they relate to correlation are discussed in detail later.

The correlation modeling module 110 can be configured to generate a similarity matrix representing correlation among the at least two voting sources 108. As noted herein, the processor 104 and the correlation modeling module 110 are configured to operate on voting output data that is stored in memory 106. To facilitate this, the processor 104 and/or the correlation modeling module 110 can generate any number of storage representations (e.g., data tables, matrices, etc.) of the voting output data. A storage representation is a representation of the voting output data that is configured to facilitate a particular type of processing of the data. A similarity matrix of the voting output data organizes the voting output data so as to allow the correlation modeling module 110 to generate mathematical vectors that, when processed in accordance with the algorithms described herein, provide analytics as to the correlation among at least two voting sources 108.

The agreement metric can be implemented for any one or combination of voting source 108 comparisons being performed. For instance, the sourcing model 102 may contain plural voting sources 108 comprising at least a first voting source 108 and a second voting source 108. When the system 100 is modeling correlation among the first voting source 108 and the second voting source 108, an agreement metric can be implemented for the comparison of first voting source 108 and the second voting source 108. In an exemplary implementation, the correlation modeling module 110 can be configured to implement the agreement metric by dividing a number of occurrences in which a voting output from a first voting source 108 agrees with a voting output from a second voting source 108 by a number of occurrences in which the voting output from the first voting source 108 and the voting output from the second voting source 108 are present. As will be explained in detail later, the agreement metric provides a measure of overlap of pairwise detection consensus among two or more voting sources 108.

The correlation modeling module 110 can be configured to generate a matrix decomposition that identifies the first-order interaction among the at least two voting sources 108. For instance, algorithmic steps can cause the correlation modeling module 110 to perform any number of matrix decomposition or matrix factorization steps to factorize the similarity matrix into a product of matrices. The correlation modeling module 110 can be configured such that the matrix decomposition generates a matrix consisting of first-order interactions among the at least two voting sources 108. The correlation modeling module 110 can be configured such that the matrix decomposition identifies first-order interactions as vectors consisting of first-order interactions from the matrix.

For instance, the correlation modeling module 110 can be configured to model the similarity matrix as

$$D = \sum {}_{i = 1}^{k} \text{triu} \left({r}_{i} {r}_{i}^{⊤} , 1\right) ,$$

wherein each rᵢ represents first-order interactions in the similarity matrix D. The correlation modeling module 110 can be configured to execute computer instructions that implement the following algorithm:

Require: Similarity matrix D, early stopping threshold δ
1: function R1SM-GREEDY(D, δ)
2: Y₁ ← D,i ← 0
3: do
4: i ← i + 1
5: Find rᵢ which maximally explains Yᵢ
6: Rᵢ ← $\text{triu} \left({r}_{i} {r}_{i}^{⊤} , 1\right)$
7: Yᵢ₊₁ ← Yᵢ - Rᵢ
8: while $\frac{\sum {R}_{i}}{\sum D} \geq δ$
9: return r₁, r₂,...rᵢ₋₁

wherein:
Yi is the residual of triu(D,1); and

$${R}_{i} = \text{triu} \left({r}_{i} {r}_{i}^{\text{T}} , 1\right) .$$

In some embodiments, the correlation modeling module 110 can be configured to generate plural similarity matrices. Each similarity matrix can be generated to represent correlation among at least two voting sources 108 at different points in time over a time period, wherein D = [D₁, D₂, ... D_{T}]. With such an implementation, the correlation modeling module 110 can be configured to execute computer instructions that implement the following algorithm: Require: Time-series of similarity matrices D = [D₁, D₂, ...D_{T}], early stopping threshold δ, and penalty term λ

1:function R1SM-T (D, δ, λ)
2: Y₁ ← D, i ← 0
3: do
4: i ← i + 1
5: Initialize network F(·)
6: while F has not converged do
7: ℓ ← 0
8: r_{i,1}, r_{i,2}, ...r_{i,T} ← F(X)
9: for t ← 1 to T do
10: ${U}_{t} ← min \left(\text{triu} \left({r}_{i , i} {r}_{i , t}^{⊤} , 1\right) ⋅ {Y}_{t , t} , 0\right)$
11: ${O}_{t} ← max \left({Y}_{i , t} - \text{triu} \left({r}_{i , t} {r}_{i , r}^{⊤} , 1\right) , 0\right)$
12: ℓ ← ℓ + ||λUₜ + Oₜ||₂
13: Back-propagate ℓ and run optimizer step.
14: r_{i,1}, r_{i,2}, ...r_{i,T} ← F(X)
15: for t ← 1 to T do
16: ${R}_{i , t} ← min \left(\text{triu} \left({r}_{i , t} {r}_{i , r}^{⊤} , 1\right) , {Y}_{i} , t\right)$
17: Y_{i+1,t} ← Y_{i,t} - R_{i,t}
18: while $\frac{\sum {R}_{i}}{\sum D} \geq δ$ 19: return r₁, r₂, ...rᵢ₋₁

wherein:
F(·) can be a deep neural network configured to optimize values in rᵢ at each iteration i;
Uₜ and Oₜ are matrices representing element-wise differences between
$$\text{triu} \left({r}_{i , t} {r}_{i , t}^{⊤} , 1\right)$$
and Y_{i,t}; and
λ = (0,1].

The output of the correlation modeling module 110 is a correlation factor or value. The correlation value can be between 0 and 1, for example. The correlation value is a measure of correlation among the voting sources 108 under examination that is attributed to first-order interactions. The system 100 can be configured to generate a correlation value for any one or combination of voting source 108 comparisons - e.g., a correlation value can be generated for each comparison between the first voting source 108 and each other voting source 108 of the plural voting sources 108, a correlation value can be generated for each comparison between the first voting source 108 and any number or combination of other voting sources 108 of the plural voting sources 108, etc. With the example in which the correlation value is between 0 and 1, the system 100 can be configured such that correlation values closer to 0 indicate that any correlation present is most likely not due to first-order interactions, and correlation values closer to 1 indicate that any correlation present is most likely due to first-order interactions. It is understood that other correlation scoring schemes can be used, e.g., 0 to 10, 1 to 100, etc.

Details of an exemplary correlation modeling process, as applied to an antivirus label decisioning sourcing model 102 are discussed next, but it is understood that the system 100 can be used to model correlation of any type of sourcing model 102. These can include crowdsourcing sourcing models 102, an antivirus label decisioning sourcing model 102, etc.

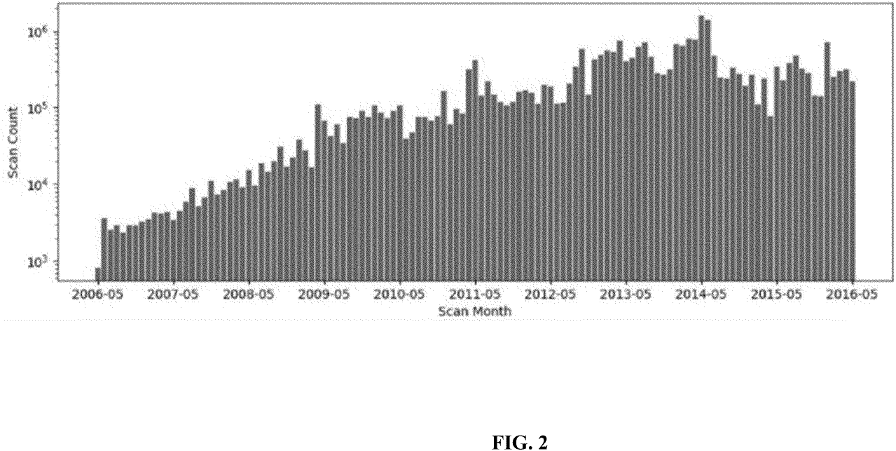

For the purposes of investigating antivirus label consensus and how antivirus dynamics have changed through time, the inventors were provided with a dataset of 25,100,286 VirusTotal scan reports [18]. This dataset, which can be referred to as VirusShare-VT, was collected by querying the VirusTotal API for all files in chunks 0 through 233 of the publicly available VirusShare malware corpus [1]. VirusTotal API queries for the VirusShare-VT dataset were made over the course of six months, from December 2015 to May 2016 [18]. Each report in the VirusShare-VT dataset is a JSON object containing information about a particular VirusTotal scan. Of note is the scan_date field, which contains the date and time that a file was scanned with the collection of antivirus engines. The scan date is often older than the query date, because VT does not re-scan files for simple queries. The distribution of scan dates is shown in FIG. 2, ranging from May 2006 to May 2016.

Given the sizeable number of malware samples in chunks 0 - 233 of VirusShare, scanning these samples daily as Zhu et al. [26] did was infeasible. The VirusShare-VT dataset only contains one scan report per sample, and antivirus detections for files first seen shortly before the scan date have likely not stabilized. However, these factors should not be considered to be drawbacks, as they would be typical of most datasets used for antivirus aggregation. The massive size and timescale of the VirusShare-VT dataset is beneficial, as it can provide useful results.

This disclosure follows terminology introduced by Hurier et al. [6] for measuring consensus among antivirus engines. Given a set of n antivirus engines A = {α₁, α₂, ..., αₙ} and a set of m files P = {p₁, p₂, ..., pₘ}, the detections and family classifications of the antivirus engines for this set of malware samples can be arranged into two matrices B and C:

$$B = \left(\begin{matrix}{b}_{1 , 1} & {b}_{1 , 2} & ⋯ & {b}_{1 , n} \\ {b}_{2 , 1} & {b}_{2 , 2} & ⋯ & {b}_{2 , n} \\ ⋮ & ⋮ & ⋱ & ⋮ \\ {b}_{m , 1} & {b}_{m , 2} & ⋯ & {b}_{m , n}\end{matrix}\right) C = \left(\begin{matrix}{c}_{1 , 1} & {c}_{1 , 2} & ⋯ & {c}_{1 , n} \\ {c}_{2 , 1} & {c}_{2 , 2} & ⋯ & {c}_{2 , n} \\ ⋮ & ⋮ & ⋱ & ⋮ \\ {c}_{m , 1} & {c}_{m , 2} & ⋯ & {c}_{m , n}\end{matrix}\right)$$

An element B_{i,j} in B is 1 if file pᵢ is detected as malware by engine αⱼ and 0 if it is not detected. An element C_{i,j} in C is given by the malware family assigned to file pᵢ by engine αⱼ. B_{i,j} and C_{i,j} are Ø (null) if engine αⱼ did not scan pᵢ. Malware labeling software tool, such as AVClass, for example, can be used. For constructing the matrix C, a portion of the AVClass labeler’s architecture was employed, which can extract family information from antivirus signatures [17]. When AVClass ingests a scan report, it normalizes and tokenizes each antivirus signature, removes any tokens that do not contain family information, and performs family alias resolution. The processed token(s) from the antivirus signature produced by engine αⱼ for file pᵢ are used as the family for element C_{i,j,}.

Hurier et al. [6] proposed a metric called “overlap” for computing pairwise detection consensus for a pair of antivirus engines. However, overlap does not consider that some antivirus engines may be missing from a scan report. Instead, embodiments of the inventive method define a similar metric, referred to as “Agreement,” that corrects this issue.

$$\text{Agreement} \left({B}_{i} , {B}_{j}\right) = \frac{\left|{B}_{i} = = {B}_{j}\right|}{\left|{B}_{i} ∪ {B}_{j}\right|} \text{s} \text{.t} \text{.} {B}_{i} , {B}_{j} \neq 0 \qquad \text{DEFINITION 1.}$$

Agreement (Bᵢ) divides the number of scans in B in which αᵢ and αⱼ agree upon a file’s detection by the total number of scans in which both αᵢ and αⱼ are present. Classification agreement can be defined in the same way by substituting the matrix B for C. Since it is possible for AVClass to convert a single antivirus signature into multiple family tokens, embodiments of the inventive method consider two elements in C to be equal if they share any AVClass tokens, or if AVClass produced zero tokens for both signatures.

The VirusShare-VT dataset contains 93 antivirus engines that appear in at least 1,000 different scan reports. The set of antivirus engines used by VirusTotal changes gradually over time. In May 2006 only 26 of the 93 engines were observed; this number gradually increases to 57 by May 2016. The sets of antivirus engines in VirusTotal are relatively consistent month-to-month, with an average of 1.033 engines added or removed per month. Several antivirus engines only appear in VirusShare-VT during a short window of time. Many of these are alternative or beta versions of existing engines (e.g., PandaBeta from February 2007 to February 2009, McAfee+Artemis from November 2008 to January 2011, and Avast5 from March 2010 to September 2011). The name, numeric index used in the corresponding figures, and total number of occurrences of each of the 93 antivirus engines in the VirusShare-VT dataset are shown in Table 1.

TABLE 1

Antivirus engines present in at least 1,000 scan reports in VirusTotal-VT.

| Index | Antivirus Engine | Scan Count | Index | Antivirus Engine | Scan Count |
|---|---|---|---|---|---|
| 0 | ALYac | 4,679,821 | 47 | McAfee+Artemis | 995,699 |
| 1 | AVG | 34,982,795 | 48 | McAfee-GW-Edition | 34,607,621 |
| 2 | AVware | 5,664,526 | 49 | McAfeeBeta | 95,784 |
| 3 | Ad-Aware | 12,649,803 | 50 | MicroWorld-eScan | 19,382,987 |
| 4 | AegisLab | 10,636,692 | 51 | Microsoft | 24,984,940 |
| 5 | Agnitum | 19,009,698 | 52 | NANO-Antivirus | 18,763,016 |
| 6 | AhnLab-V3 | 23,792,676 | 53 | NOD32 | 4,738,012 |
| 7 | Alibaba | 4,657,472 | 54 | NOD32Beta | 343,198 |
| 8 | AntiVir | 19,225,387 | 55 | NOD32v2 | 245,233 |
| 9 | Anitvir7 | 8,710 | 56 | Norman | 21,187,821 |
| 10 | Antiy-AVL | 24,559,174 | 57 | PCTools | 11,426,342 |
| 11 | Arcabit | 3,770,802 | 58 | Panda | 24,713,903 |
| 12 | Authentium | 1,778,226 | 59 | PandaB3 | 2,695 |
| 13 | Avast | 24,945,279 | 60 | PandaBeta | 288,403 |
| 14 | Avast5 | 2,405,851 | 61 | PantaBeta2 | 3,371 |
| 15 | Avira | 5,432,038 | 62 | Prevx | 3,826,154 |
| 16 | Baidu | 752,127 | 63 | Prevx1 | 438,718 |
| 17 | Baidu-International | 13,770,014 | 64 | Qihoo-360 | 11,703,897 |
| 18 | BitDefender | 25,037,371 | 65 | Rising | 24,233,086 |
| 19 | Bkav | 13,155,628 | 66 | SAVMail | 149,834 |
| 20 | ByteHero | 20,476,926 | 67 | SUPERAntiSpyware | 23,567,247 |
| 21 | CAT-QuickHeal | 25,048,885 | 68 | SecureWeb-Gateway | 101,352 |
| 22 | CMC | 11,819,228 | 69 | Soplios | 24,540,725 |
| 23 | ClamAV | 25,007,198 | 70 | Sunbelt | 1,741,218 |
| 24 | Command | 250,234 | 71 | Symantec | 24,732,139 |
| 25 | Commtouch | 17,141,359 | 72 | T3 | 18,501 |
| 26 | Comodo | 24,666,456 | 73 | Tencent | 8,606,167 |
| 27 | Cyren | 5,885,738 | 74 | TheHacker | 25,053,441 |
| 28 | InWeb | 24,599,903 | 75 | TotalDefense | 20,294,251 |
| 29 | ESET-NOD32 | 19,964,248 | 76 | TrendMicro | 24,752,548 |
| 30 | Emsisoft | 22,526,376 | 77 | TrendMicro-Housecall | 23,560,584 |
| 31 | Ewido | 292,281 | 78 | UNA | 44,282 |
| 32 | F-Prot | 25,36,409 | 79 | VBA32 | 24,870,783 |
| 33 | F-Prot4 | 26,895 | 80 | VIPRE | 23,181,524 |
| 34 | F-Secure | 24,060,788 | 81 | ViRobot | 24,843,379 |
| 35 | FileAdvisor | 129,111 | 82 | VirusBuster | 5,365,970 |
| 36 | Fortinet | 25,045,656 | 83 | Webwasher-Gateway | 202,898 |
| 37 | FortinetBeta | 89,667 | 84 | Yandex | 564,996 |
| 38 | GData | 24,831,415 | 85 | Zillya | 8,444,657 |
| 39 | Ikarus | 25,087,466 | 86 | Zoner | 7,351,648 |
| 40 | Jiangmin | 24,011,547 | 87 | a-squared | 1,135,672 |
| 41 | K7AntiVirus | 24,510,017 | 88 | eSafe | 9,936,896 |
| 42 | K7GW | 16,303,096 | 89 | eScan | 37,174 |
| 43 | Kaspersky | 24,721,716 | 90 | eTrust-InoculateIT | 35,112 |
| 44 | Kingsoft | 17,919,699 | 91 | eTrust-Vet | 4,731,780 |
| 45 | Malwarebytes | 18,710,973 | 92 | nProtect | 24,252,689 |
| 46 | McAfee | 24,949,683 | | | |

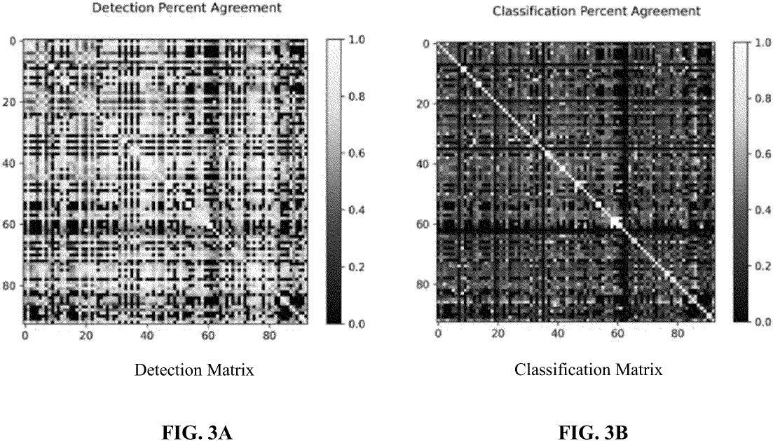

The index column displays to which row and/or column in FIGS. 3A, 3B, 5, 7, 10, and 11 each engine corresponds.

FIGS. 3A and 3B show the pairwise detection and classification agreement for each of these 93 antivirus engines. Consistent with prior work, there are observable instances of high detection consensus among the antivirus engines of some vendors, and the antivirus engines in a small subset of vendors’ antivirus engines have very little agreement with other antivirus engines [9]. The classification agreement matrix appears highly similar in structure to the detection matrix but with smaller values on average. One possible explanation for this phenomenon is that classification agreement between two antivirus engines depends upon both antivirus engines detecting the sample as malware and then similarly classifying it.

Next, how overall consensus among antivirus engines has changed over time is explored. Consider a similarity matrix D constructed by applying some similarity function sim(Bᵢ, Bⱼ) to each pair of antivirus engines in antivirus engine A. Let Σ D denote the sum of all elements in D. Because values below the main diagonal of a similarity matrix are redundant, the triu(X, i) function is defined to return X where all elements at or below the i^{th} diagonal are replaced with zero. In the present disclosure, it is implicit that redundant information has already been removed for all future references to similarity matrices, i.e., D has been replaced with triu(D, 1). “Synchronicity” can be used to measure overall consensus among a set of antivirus engines and is defined as [6]:

$$\text{Syncronicity} \left(B\right) = \frac{\sum \text{triu} \left(D , 1\right)}{n \left(n - 1\right) / 2} \qquad \text{DEFINITION 2.}$$

Synchronicity is equivalent to the average value of the entries above the main diagonal of D. Synchronicity is defined herein using different notation than Hurier et al. [6] so as to be consistent with terminology used later in the present disclosure. When computing the similarity matrix D, sim(Bᵢ, Bⱼ) can be any pairwise similarity function; agreement is elected as this similarity function in all of the experiments. Although Hurier et al. [6] define synchronicity only for measuring the level of consensus among antivirus engines, it can also measure classification consensus by computing a similarity matrix for C instead of B.

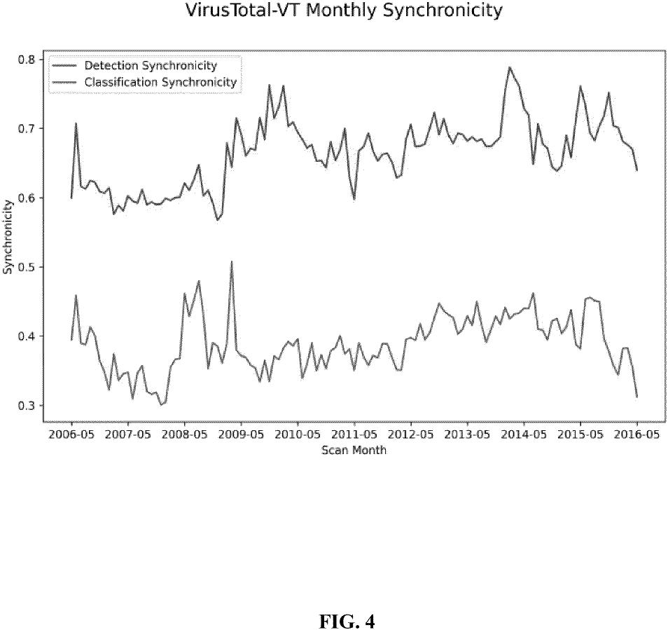

FIG. 4 displays how the synchronicity of the antivirus engines in the VirusShare-VT dataset changes over time. This data was collected by grouping the scans in VirusShare-VT by month and computing detection and classification synchronicity for each group of scans. It is evident that synchronicity among antivirus engines varies considerably over short spans of time. Although they have different magnitudes, detection and classification synchronicity seem to be loosely correlated. Again, a possible explanation for this is that classification must follow detection.

At first, it was believed that one factor which contributed to the volatility shown in FIG. 4 was antivirus engines joining and leaving the VirusTotal platform. Yet, as noted earlier, changes in the set of antivirus engines used by VirusTotal tend to be very gradual. However, three events were identified in which four or more antivirus engines were added or removed in the span of a one month period. One of these events represents the most significant population shift in the set by far: the removal of fourteen antivirus engines from Jan. to February 2009. This corresponds to an increase in detection synchronicity from 0.577 to 0.679 during this period, though change in classification synchronicity is negligible. The other two events are the additions of four antivirus engines from Aug. to September 2008 and five antivirus engines from Aug. to September 2013. However, synchronicity does not change significantly during either of these periods. It would be difficult for changes in synchronicity to occur due to population changes unless a significant number of engines join or leave. In addition, other significant increases and decreases in synchronicity were observed during periods when the population of antivirus engines did not change. It can be concluded that changes in synchronicity among antivirus engines are likely caused by a complex assortment of factors, including changes in both the malware ecosystem and antivirus community.

All current explanations for consensus among antivirus engines can be classified as assuming the consensus results from first-order interactions, i.e., a single interaction between a pair of features. To test this widely held assumption, an extension to Rank-1 Similarity Matrix (R1SM) decomposition, called Temporal Rank-1 Similarity Matrix Decomposition (R1SM-T), is introduced. RISM-T reveals changes in first-order interactions within time series data and is discussed below.

Assume a similarity matrix D represents agreement between each pair of antivirus engines in A. The R1SM decomposition can expose first-order interactions among the antivirus engines in the upper triangular of D as the sum of rank-1 outer products with shared, non-negative weights.

$$D = \sum {}_{i = 1}^{k} \text{triu} \left({r}_{i} {r}_{i}^{⊤} , 1\right) \qquad \text{DEFINITION 3.}$$

In Definition 3, each vector r₁, r₂, ... rₖ has length n and is non-negative. First-order interactions between objects in D manifest in these vectors are components of the decomposition. The behavior of first-order interactions between objects manifesting themselves in the components of the decomposition occurs due to the nature of the decomposition, in which the outer product of each vector rᵢ and its transpose forms a rank-1 matrix (a matrix containing only first-order interactions by definition).

The R1SM decomposition is comparable to the existing CANDECOMP/PARAFAC (CP) decomposition, which also decomposes a tensor into a sum of rank-one outer products [10]. However, additional restrictions (e.g., the decomposition can only be applied to the upper triangular of a square, non-negative matrix and the rank-one outer products have shared weights), inter alia, distinguish the R1SM decomposition from the CP decomposition.

Next, how the R1SM decomposition is computed is discussed. A trivial solution of the R1SM decomposition exists for all similarity matrices in which each component determines a single value in one of the n (n - 1)/2 elements in the upper triangular. However, this solution does not provide any useful insights about first-order interactions in the decomposed similarity matrix. As one of the goals is to determine which portion of the correlations can be explained by first-order interactions, the components of the R1SM decomposition are solved using an iterative, greedy strategy.

Algorithm 1 R1SM Greedy Decomposition
Require: Similarity matrix D, early stopping threshold δ

| | |
|---|---|
| 1: | function R1SM-GREEDY(D,δ) |
| 2: | Y₁ ← D, i ← 0 |
| 3: | do |
| 4: | i ← i + 1 |
| 5: | Find rᵢ which maximally explains Yᵢ |
| 6: | Rᵢ ← $\text{triu} \left({r}_{i} {r}_{i}^{⊤} , 1\right)$ |
| 7: | Yᵢ₊₁ ←Yᵢ - Rᵢ |
| 8: | while $\frac{\sum {R}_{i}}{\sum D} \geq δ$ |
| 9: | return r_{1,} r₂, ...rᵢ₋₁ |

Algorithm 1 can approximate the R1SM decomposition of a similarity matrix D. At the beginning of the i^{th} iteration of the algorithm, Yᵢ is the residual of triu(D, 1), representing the portion of the similarity matrix that has not yet contributed to the decomposition. At each step of the decomposition, a component rᵢ is found such that rᵢ maximally explains Yᵢ, i.e. the maximum value of Σ Rᵢ for which Yi - Rᵢ is non-negative, where Rᵢ = triu(rᵢ rᵢ^{T}, 1) (line 5). Later in the disclosure, implementation for finding components that maximally explain Yi is discussed. After solving for rᵢ, the updated residual Yᵢ₊₁ is computed by subtracting Rᵢ from Yᵢ (line 7).

Each component of the R1SM decomposition can explain a portion of the similarity matrix, given by

$$\frac{\sum {R}_{i}}{\sum D} .$$

Due to the greedy nature of Algorithm 1, the percentage of the similarity matrix explained by subsequent components tends to decrease monotonically. Once a component fails to explain a meaningful percentage of the similarity matrix, it is unlikely that any subsequent component will. Once the algorithm reaches this point, it can be assumed with reasonable certainty that most if not all significant first-order interactions have been captured by the decomposition, and all further information left to be explained may be better represented by a more complex model. Therefore, iteration of Algorithm 1 halts if a component is found for which

$$\frac{\sum {R}_{i}}{\sum D}$$

is less than δ, which defaults to 0.1% (line 8). If a significant portion of D can be decomposed before the early stopping condition is reached, it can be concluded that most of the interactions between the antivirus engines represented by D are first-order. A complete decomposition of D can be obtained by setting δ to zero, in which Algorithm 1 will iterate until triu(Yᵢ, 1) stores the zero matrix.

Each component rᵢ of the R1SM composition represents first-order interactions between objects in a similarity matrix. As such, each component can be interpreted as a cluster, where large values in a component indicate a strong first-order relationship between the corresponding objects. Unlike traditional methods for clustering objects in a similarity matrix (such as agglomerative hierarchical clustering), which group objects by their overall similarity, the clusters produced by the R1SM decomposition can indicate groups with prominent first-order interactions. It should be stressed that clustering is not the primary motivation of the R1SM decomposition, but the idea is explored due to its usefulness.

Because the rᵢ are not sparse, they may contain small, even spurious values that are not indicative of significant first-order interactions between objects. Thus a parameter ∈ can be used to influence which members of a component are considered “clustered” (i.e., a non-trivial first-order correlate). For a component rᵢ, the j^{th} object is a member of cluster i if rᵢⱼ ≥ ∈. A large ∈ results in smaller clusters, where all objects within a cluster have strong first-order interactions between each other. Conversely, a small ∈ yields larger clusters, but objects within a cluster may have weaker first-order interactions. An object may be a member of multiple clusters or none at all, and it is possible for a cluster to contain zero objects. The early stopping term δ can also be used to control the resulting clustering, as it can be configured to determine the maximum number of clusters. As will be discussed later, the clustering property of the R1SM decomposition can be taken advantage of to identify groups of antivirus engines that share strong first-order interactions.

Algorithm 2 R1SM-T Decomposition
Require: Time -series of similarity matrices D = [D₁, D₂, ... DT], early stopping threshold δ, and penalty term λ

| | |
|---|---|
| 1: | function R1SM-T(D, δ, λ) |
| 2: | Y₁ ← D, i ← 0 |
| 3: | do |
| 4: | i ← i + 1 |
| 5: | Initialize network F(·) |
| 6: | while F has not converged do |
| 7: | l ← 0 |
| 8: | r_{i,1}, r_{i,2},...r_{i,T} ← F(X) |
| 9: | for t ← 1 to T do |
| 10: | ${U}_{t} ← min \left(\text{triu} \left({r}_{i , t} {r}_{i , t}^{\text{T}} , 1\right) - {Y}_{i , t} , - 0\right)$ |
| 11: | ${O}_{t} ← max \left({Y}_{i , t} - \text{triu} \left({r}_{i , t}^{\text{T}} , 1\right) , 0\right)$ |
| 12: | ℓ ← ℓ +∥λUₜ + Oₜ∥₂ |
| 13: | Back-propagate ℓ and run optimizer step. |
| 14: | r_{i,1},r_{i,2},...r_{i,T} ← F(X) |
| 15: | for t ← 1 to T do |
| 16: | ${R}_{i , t} ← min \left(\text{triu} \left({r}_{i , t} {r}_{i , t}^{⊤} , 1\right) , {Y}_{i , t}\right)$ |
| 17: | Y_{i+1,t} ← Y _{i,t} - R_{i,t} |
| 18: | while $\frac{\sum {R}_{i}}{\sum D} \geq δ$ |
| 19: | return r₁, r₂, ...rᵢ₋₁ |

Algorithm 2 describes the concurrent R1SM decomposition of multiple similarity matrices while sharing information across all matrices as a function of their spatial relationships in time. During the i^{th} iteration, Yᵢ = [Y_{i,1}, Y_{i,2}, ...Y_{i,T]} stores the residual of each similarity matrix in D. Like Algorithm 1, components = [r_{i,1}, r_{i,2}, ...r_{i,T}] are found such that they each maximally explain their respective matrices in Yᵢ (lines 6 - 13). The implementation for finding these components is described momentarily. A heavy penalty term discourages any values in

$$\text{triu} \left({r}_{i , t} {r}_{i , t}^{T} , 1\right)$$

from exceeding their corresponding values in Y_{i,t}, but minute errors are still possible. Therefore, for each time t,

$$\text{triu} \left({r}_{i , t} {r}_{i , t}^{T} , 1\right)$$

is corrected using Y_{i,t} and the result is stored in R_{i,t} (line 16). Y_{i+1,t}, the new residual of triu(D, 1), is computed by subtracting R_{i,t} from Y_{i,t} (line 17). Like Algorithm 1, iteration stops once components are found such that

$$\frac{\text{Σ} {R}_{i}}{\text{Σ} D}$$

< δ (line 18).

The implementation can use a deep neural network F(·) over positional embeddings to concurrently solve the next component in the R1SM decomposition for each similarity matrix in the time-series. This model design was selected so that non-linear changes in consensus over time can be learned. Furthermore, positional embeddings allow the model to leverage temporal relationships between the target similarity matrices as the primary factor of changes in consensus. F(·) can be trained on a batch of input vectors X = [X₁, X₂, ..., X_{T}], where each vector Xₜ is the positional embedding of timestep t in the time-series. To obtain the positional embedding of t,

$$\frac{\text{d}}{2}$$

distinct frequencies ƒ₁, ƒ₂, ...ƒ_{d/2}, can be defined, where d can represent the size of the neural network’s input layer and the j^{th} frequency is given by

$${f}_{j} = \frac{\text{t}}{10000 \frac{2 j}{d}} .$$

Xₜ can be constructed by alternately applying the sin() and cos() functions to each frequency as shown below [20].

$${X}_{t} = {\left[sin \left({f}_{1}\right) , cos \left({f}_{1}\right) , … , sin \left({f}_{\frac{d}{2}}\right) , cos \left({f}_{\frac{d}{2}}\right)\right]}^{\text{T}} \qquad \text{DEFINITION 4.}$$

The use of a single network that predicts a component for each similarity matrix based on positional embeddings can permit information sharing across time while simultaneously allowing the model to adjust the results over time. In doing so, the model can gain the ability to learn meaningful results during periods in which less data is available, adapting to the rate of change that is present in the data. That is to say, if time is not relevant at all, the model can learn to ignore the input embedding Xₜ entirely. If time is relevant, the embeddings Xₜ and X_{t+Δ} have a relationship that can be extracted by a single layer of a neural network [20], allowing for information sharing over time. This information sharing can be important, as different rates of change over time are observed, and the amount of samples per month varies by up to three orders of magnitude (see FIG. 2).

During each iteration i, a new neural network (·) can optimize the values in components rᵢ = [r_{i,1}, r_{i,2}, ...r_{i,T}] such that they each maximally explain their respective matrices in Yᵢ (lines 6 -13). The loss l of F(X) can be computed using two matrices Uₜ and Oₜ, which represent element-wise differences between

$$\text{triu} \left({r}_{i , t} {r}_{i , t}^{T} , 1\right)$$

and Y_{i,t} per timestep. Uₜ can store under-predictions in

$$\text{triu} \left({r}_{i , t} {r}_{i , t}^{T} , 1\right)$$

(line 10) and Oₜ can store over-predictions in

$$\text{triu} \left({r}_{i , t} {r}_{i , t}^{T} , 1\right)$$

(line 11). (·) can be strongly discouraged from over-predicting Yᵢ by a λ hyper-parameter, which has a value in the range (0, 1], and is set to 0.01 by default. λ can act as a scaling factor between U and O, causing values in O to contribute more heavily to the loss (line 12). Due to this term, over-prediction of the values in the components may be rare. Once the batch loss has been computed, the model can be configured to perform back-propagation and the optimizer step (line 13). Training can continue until the model converges, at which point rᵢ holds an optimal solution. Algorithm 2 can solve the R1SM decomposition of a single similarity matrix by defining it as a time-series with only one timestep.

The implementation of the neural network (·) can use ten hidden layers with five residual connections. The default hidden layer size can be 1,024 neurons, and the network may include multiple bottleneck layers whose sizes are a function of the input and output layer sizes. The exp() function can be applied to all weights in the output layer of F(·), constraining the predicted components to be non-negative as required by the definition of the R1SM decomposition. An important design factor can be the use of a very small learning rate, which can allow for precise adjustments to the values in the component during the learning process. By default, R1SM-T can use a learning rate of 1e-7 (or 10⁻⁷). In extended tests, a wide array of layer depths, residual and/or simple feed-forward connections, and numbers of neurons per layer, produced qualitatively and quantitatively the same results, as the networks are learning to predict population level statistics without explicit features about the populations, forcing the network to learn consistent population behaviors.

Now that the R1SM decomposition and R1SM- T are introduced, they can be used to study first-order interactions among the antivirus engines in the VirusTotal-VT dataset. First, the validity of the industry assumption that consensus among antivirus engines is caused by first-order interactions, such as sharing of threat intelligence and copying from leading vendors of antivirus engines, is investigated. Clusters of antivirus engines with strong first-order interactions can be identified. How first-order interactions among antivirus engines have changed over the course of a decade can be researched.

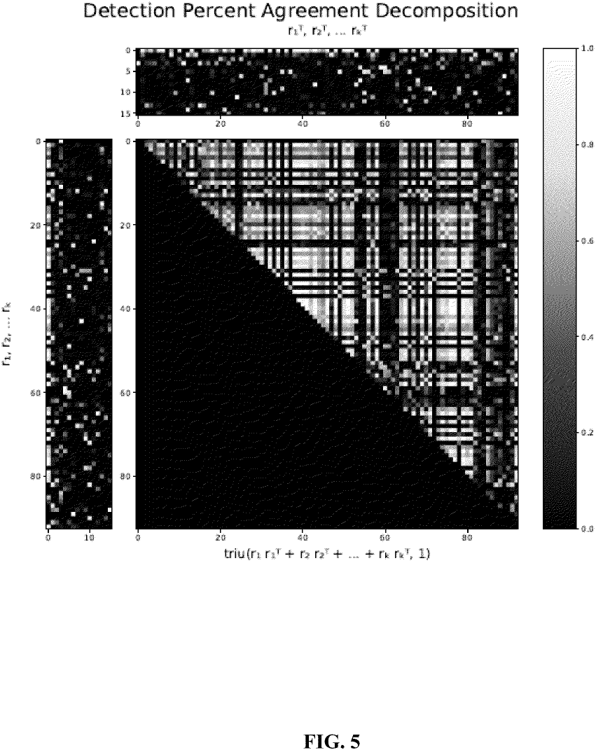

FIG. 5 displays the R1SM decomposition of the similarity matrix shown in FIG. 3A, which measures pairwise detection agreement among the antivirus engines in the VirusShare-VT dataset. This decomposition was obtained by applying Algorithm 2 to the similarity matrix, represented as a time-series with a single timestep. Using an early stopping threshold of δ = 0.1%, the decomposition yielded k = 16 components which explain 60.596% of the matrix. That approximately 40% of the matrix went unexplained implies that significant amounts of the consensus among antivirus engines cannot be explained by first-order interactions alone, which runs counter to current prevalent belief.

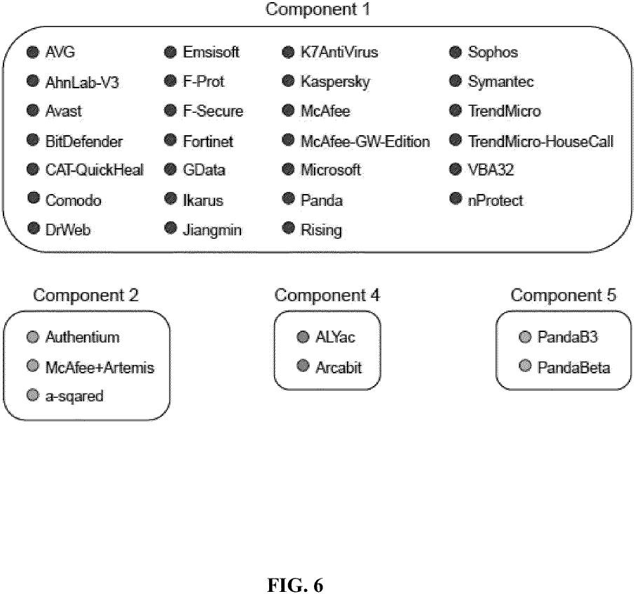

FIG. 6 displays clusters extracted from the R1SM decomposition in FIG. 5 using ∈ = 0.85. Components with less than two antivirus engines exceeding ∈ are not shown. The clustering illustrates a common trait of the R1SM decomposition, namely that the first component tends to subsume a large quantity of the similarity matrix, resulting in a large cluster for the first component. The cluster extracted from the first component indicates that a significant number of first-order interactions exist among a large group of antivirus engines. Inspection of the clustering shows pairs of antivirus engines with a shared vendor, such as TrendMicro and TrendMicro-Housecall as well as PandaB3 and PandaBeta. Other antivirus engines in the clusters have been previously reported to have similarities, such as BitDefender, Emsisoft, and GData; McAfee, McAfee-GW-Edition, and Microsoft; and Avast, AVG, and Fortinet [16, 26].

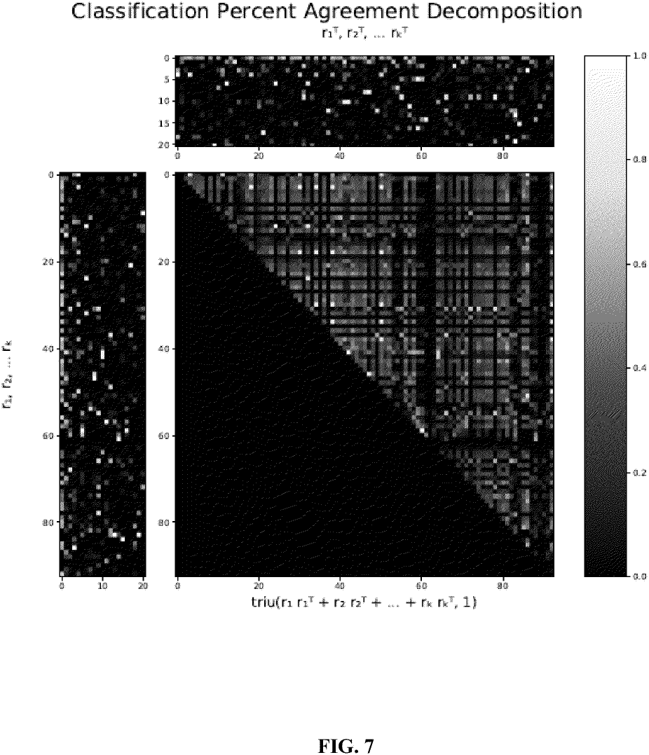

FIG. 7 shows the R1SM decomposition of the similarity matrix shown in FIG. 3B, which contains pairwise classification agreement scores for the antivirus engines in VirusShare-VT. This decomposition has k = 21 components which explain 58.394% of the matrix. As with the prior decomposition, a significant portion of the similarity matrix cannot be explained using first-order interactions alone, and further work may be needed to identify and model the complex relationships among this set of antivirus engines. Comparing the central subplots of FIGS. 5 and 7 shows that both decompositions are structurally alike, indicating that many of the same first-order interactions exist among the antivirus engines whether measuring detection or classification agreement. Again, the time-series for the two similarity matrices also have R1SM-T decompositions with notable similarities.

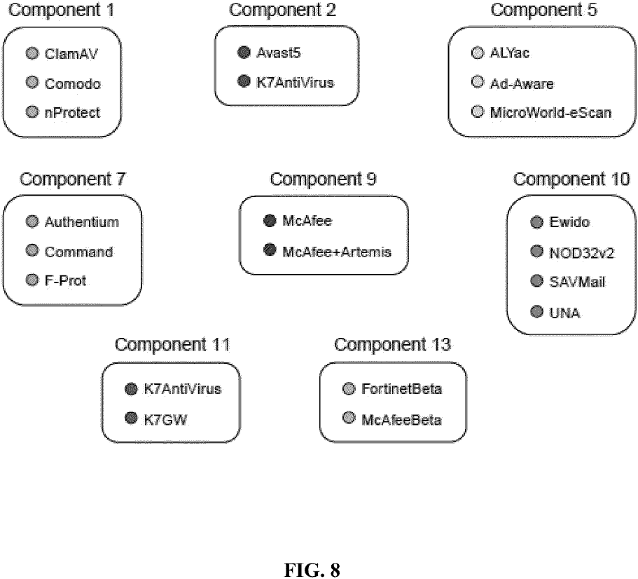

FIG. 8 shows the clusters extracted from the classification percent agreement R1SM decomposition in FIG. 7 using ∈ = 0.7. Again, components with less than two antivirus engines exceeding ∈ are not displayed. Shared vendor relationships between Authentium and Command, McAfee and McAfee+Artemis, and K7AntiVirus and K7GW are identified by the clusters for components 7, 9, and 11 respectively. Zhu et al. [26] identify similarities between ClamAV and Comodo (component 1) as well as Ad-Aware and MicroWorld-eScan (component 5). Sebastian et al. [16] also report that the Ad-Aware and MicroWorld-eScan engines frequently have identical labels. No prior work has identified similarities between any antivirus engines developed by Fortinet and McAfee, but in 2019 the two vendors released a joint endpoint security solution [4]. A partnership between Fortinet and McAfee likely accounts for the first-order interactions between their two beta engines in component 13. Publicly known connections among the remaining clustered antivirus engines have not been found.

Next, the changes in first-order interactions among antivirus engines in the VirusShare-VT dataset over the course of a decade were investigated. To do this, VirusShare-VT was separated into groups of antivirus scans by month, and detection and classification agreement similarity matrices were computed for each group. The similarity matrices were then arranged into two time-series representing monthly change in classification and detection agreement respectively. Finally, R1SM-T was applied to both time-series.

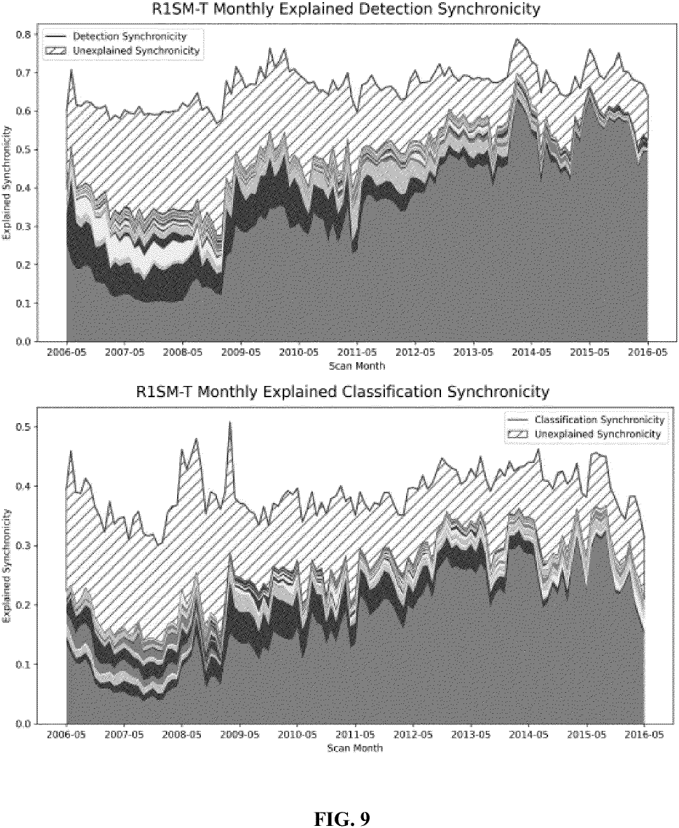

The R1SM-T models for the detection and classification agreement time-series converged after 5,200,000 and 5,440,000 training iterations, respectively. They each identified k = 26 sets of components using the early stopping value δ = 0.1%. The R1SM-T decomposition for the detection percent agreement time-series explains an average of 73.709% of the matrices and the decomposition for the classification percent agreement time-series explains an average of 67.196% of the matrices. Interestingly, the percent explained by the R1SM-T decomposition varies monthly, as shown in FIG. 9. In this figure, the upper red line of each plot indicates monthly changes in synchronicity, originally shown in FIG. 4. Each region shaded in blue represents how much a component of the decomposition contributes to the monthly synchronicity, given by

$$\frac{\text{Σ} {R}_{i , t}}{n \left(n - 1\right) / 2} .$$

Synchronicity that cannot be explained by first-order interactions captured in the decomposition are represented by the area shaded in red. In both plots, the proportion of synchronicity explained by first-order interactions slowly increases. Although the cause of this trend is unknown, a possible explanation is an increase in sharing of threat intelligence throughout the industry over time. In both plots, the first component steadily becomes the dominant contributor to the explained synchronicity over time. Before 2009, the other components supplied approximately half of the explained synchronicity, but they became negligible by 2014. This seems to indicate that sharing of threat intelligence used to be limited to disparate groups of antivirus engines, but over time information sharing has become ubiquitous. This also correlates with usage of VirusTotal itself within industry, as it provides extensive threat intelligence tooling and a community-based platform for sharing information about malware samples.

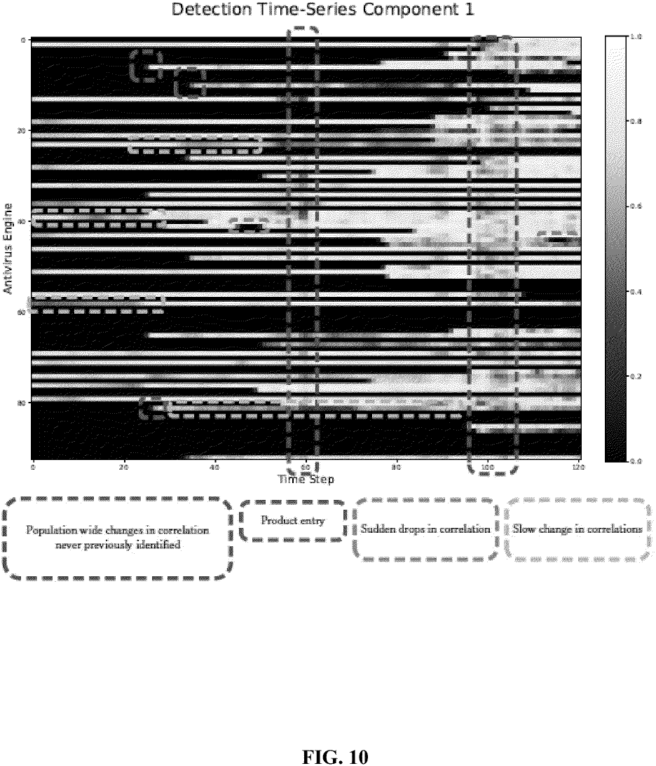

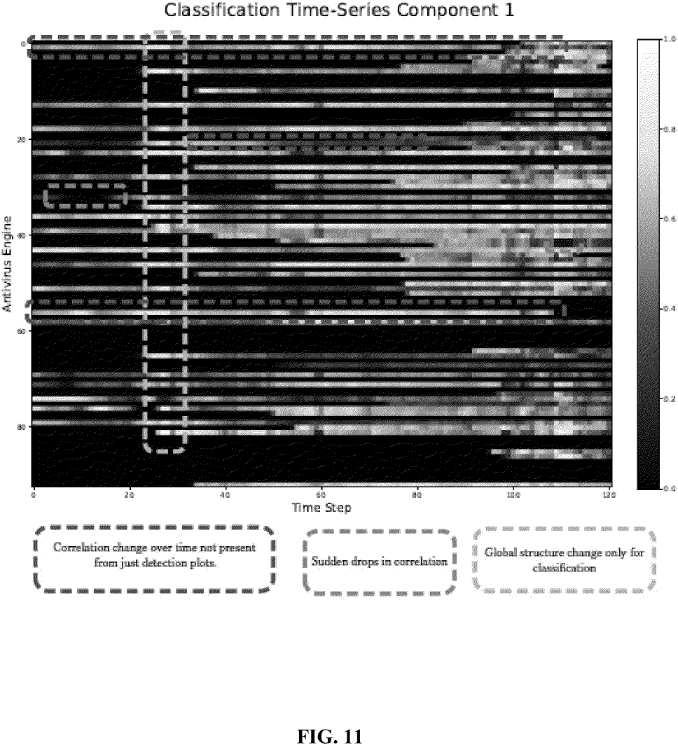

Next, the first R1SM-T component of both time-series is investigated due to its intriguing behavior in FIG. 9. In doing so, how the behaviors of individual antivirus engines is observed, as well as overall trends in the antivirus community change over time. FIGS. 10-11 display the first component of the R1SM decomposition for each of the 121 similarity matrices in the two time-series. Each column represents the component for a particular month, and each row indicates how the contributions of a specific antivirus engine to the first component have changed over time.

The overall magnitude of the components within FIG. 11 is lower than their counterparts in FIG. 10, and month-to-month component values have more variability. However, the similarity in structure between the two decompositions is striking. As with earlier findings for the two R1SM decompositions, a possible explanation for this structural similarity is that classification depends upon detection. These results could also indicate that the same types of first-order interactions tend to exist among antivirus engines regardless of whether detection or classification agreement is measured. Next, notable types of features visible in the decomposition that indicate changes in first-order interactions among antivirus engines is discussed.

Insights into alterations in antivirus behavior can be observed when corresponding values in the decomposition change radically within a short time period. Both decompositions clearly reflect changes in correlation during the months in which antivirus engines were added to the VirusTotal platform, such as Alyac in November 2014 (row 0) [22]. The June 2015 retirement of the Norman antivirus engine from VirusTotal is also reflected in both decompositions (row 56) [23].

Vertical “bands” in the R1SM-T decompositions indicate periods of change within the entire antivirus community that have never been previously noted or identified. A band evident in both FIGS. 10-11 takes place during Apr. and May 2011 (columns 59 and 60), in which values for a number of antivirus engines, including Avast (row 13), Emsisoft (row 30), F-Prot (row 32), GData (row 38), Ikarus (row 39), Rising (row 65), Sophos (row 69), TheHacker (row 74), VIPRE (row 80) drop sharply. A second band beginning in July 2014, which lasts until February 2015 in FIG. 10 and until May 2015 in FIG. 11, indicates a turbulent period where the relationships among antivirus engines were in flux. The components in FIG. 11 immediately following this band change drastically, with many antivirus engines gaining a greater share of the component in comparison to the prior months. An understanding of the cause of these community-wide disturbances in correlation may require further research, but it is in the interest of antivirus engine vendors to immediately consider how they design their label aggregation pipelines based on the insights above. For instance, any training data labeled during these time periods can be regarded as potentially suspect, and such data should undergo further analysis to confirm label quality.

Individual changes to an antivirus engine within a short period of time also indicate notable events. In FIG. 10, a large gap occurs for K7 Antivirus (row 41) from February 2010 to July 2010, which corresponds with the release of K7 TotalSecurity version 10.0 on Feb. 23, 2010 [15]. Aegislab (row 4) fluctuates significantly for unknown reasons, dropping from 0.575 when it was first introduced to VirusTotal in February 2014 [21] to 0.146 and rising back to a peak of 0.716 in August 2014. Aegislab’s contributions to the first component are nearly identical to those of Alibaba (row 7) throughout all of 2015, possibly indicating a common information source.

Since the first components of both R1SM-T decompositions are structurally very similar, differences between the two may indicate first-order correlations are caused by factors related to either benign/malicious detection or family classification alone. These factors could include increased or reduced use of heuristic antivirus signatures or changes in malware family naming conventions. External events, such as the emergence of new malware families, could also explain these discrepancies.

The R1SM-T decompositions in FIGS. 10-11 reveal that correlations among antivirus engines can change significantly within a short time period. Furthermore, they illustrate periods of industry-wide change that have never been previously identified. Although this disclosure explains many of the features in the decompositions, factors that cause consensus among antivirus engines to change are still largely unknown, and identifying the sources that cause periods of population-wide volatility is especially important.

The field in this art lacks complete understanding of the factors that cause correlations among antivirus engines; first-order interactions alone are not sufficient for modeling the complex interconnections among antivirus engines. In studying how consensus among antivirus engines changes over time, it was found that the relationships among antivirus engines are even more intricate and volatile than previously thought. The overall level of consensus among antivirus engines can change quickly in short periods of time for reasons which are still not fully understood. Using R1SM-T, it was found that first-order interactions have become increasingly responsible for consensus among antivirus engines over time, although they are still insufficient for modeling some of the sources of antivirus correlations. Furthermore, it was found that first-order interactions now seem to be nearly ubiquitous across the entire antivirus industry, whereas disparate segments of the industry previously existed where first-order interactions could not be identified. Finally, it is shown that components of R1SM-T could be utilized to identify individual and population-wide changes in antivirus behavior.

Current understanding of antivirus dynamics is clearly insufficient and more research about the causes of antivirus correlation is needed. It is difficult to trust antivirus results when the factors that cause them to be correlated are still poorly understood. Because of this and the substantial volatility of changes in relationships among antivirus engines, existing methods for aggregating antivirus signatures for the purposes of malware detection and classification are flawed. Future aggregation approaches should consider weighted ensembles where the weights of the voting members are also a function of time. Elements of this work, such as the ability to quantify first-order relationships and assess changes in these relationships over time, may themselves contribute towards improvements in antivirus aggregation.

With weighted ensembles in mind, an exemplary embodiment of the system 100 can include a processor 104. The processor 104 can be configured to collect voting output from plural voting sources 108 and store the voting output in memory 106. The system 100 can include a correlation modeling module 110. The correlation modeling module 110 can be configured to retrieve at least two voting outputs from memory 106. It is contemplated for each voting output to be from a different voting source 108. The correlation modeling module 110 can be configured to determine correlation among at least two voting sources 108 by measuring consensus among the at least two voting sources 108 using an agreement metric. The correlation modeling module 110 can be configured to determine a degree of a first-order interaction among the at least two voting sources 108. The correlation modeling module 110 can be configured to determine a degree of correlation among the at least two voting sources 108 attributed to the first-order interaction.

The processor 104 can be configured to assign a weight factor to each voting source 108 of the at least two voting sources 108 based on the degree of correlation attributed to the first-order interaction. In some embodiments, the processor 104 can be configured to assign a weight factor value that is inversely proportional to the degree of correlation attributed to the first-order interaction. Other schemes for assigning weights can be used. For instance, supposed the system 100 is used to model correlation among anti-virus engine-1, anti-virus engine-2, anti-virus engine-3, and anti-virus engine-4. Suppose the system 100 generates a correlation factor of 1.0 as a degree of correlation between anti-virus engine-1 and anti-virus engine-2 attributed to the first-order interaction. Further suppose the system 100 generates a correlation factor of 0.0 as a degree of correlation between anti-virus engine-1 and the other anti-virus engines, and a correlation factor of 0.0 as a degree of correlation among all the other anti-virus engines. The processor 104 can assign a weight to the voting output from anti-virus engine-1 and the same or different weight to the voting output from anti-virus engine-2 and combine the voting output such that the voting output by both of them is considered as a vote from a single voting source 108 - i.e., they are essentially acting in full correlation so their voting output should be considered as a vote coming from a single voting source 108. This can involve combining voting output and then weighing, weighing voting output and then combining, etc. As another example, the processor 104 can assign a weight of ½ to the voting output from anti-virus engine-1 and ½ to the voting output from anti-virus engine-2. In addition, the processor 104 can assign a weight of 1 to the voting outputs of anti-virus engine-3 and to the voting outputs of anti-virus engine-4. These assignments of weights are exemplary, and it is understood that other weighting and assignment schemes can be used.

Embodiments can relate to a method for modeling correlation in a sourcing model 102. The method can involve retrieving at least two voting outputs from plural voting sources 108. It is contemplated for each voting output of the at least two voting outputs to be from a different voting source 108. The method can involve determining correlation among at least two voting sources 108 by measuring consensus among the at least two voting sources 108 using an agreement metric. The method can involve determining a degree of a first-order interaction among the at least two voting sources 108. The method can involve determining a degree of correlation among the at least two voting sources 108 attributed to the first-order interaction.

The method can involve generating a similarity matrix representing correlation among the at least two voting sources 108. The method can involve implementing the agreement metric by dividing a number of occurrences in which a voting output from a first voting source 108 agrees with a voting output from a second voting source 108 by a number of occurrences in which the voting output from the first voting source 108 and the voting output from the second voting source 108 are present. The method can involve generating a matrix decomposition that identifies the first-order interaction among the at least two voting sources 108.

In some embodiments, the matrix decomposition generates a matrix consisting of first-order interactions among the at least two voting sources 108. In some embodiments, the matrix decomposition identifies first-order interactions as vectors consisting of first-order interactions from the matrix. In some embodiments, the sourcing model includes a crowdsourcing model, an antivirus label decisioning model, etc.

It will be understood that modifications to the embodiments disclosed herein can be made to meet a particular set of design criteria. For instance, any of the components of the system 100 can be any suitable number or type of each to meet a particular objective. Therefore, while certain exemplary embodiments of the system 100 and methods of using the same disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

The following references are incorporated by reference in their entirety.

Virusshare.com - because sharing is caring. https://virusshare.com/, Last accessed on 2020-3-9.
Ulrich Bayer, Paolo Milani Comparetti, Clemens Hlauschek, Christopher Kruegel, and Engin Kirda. Scalable, behavior-based malware clustering. In NDSS 2009, 16th Annual Network and Distributed System Security Symposium, February 8-11, 2009, San Diego, USA, San Diego, UNITED STATES, 02 2009. URL http: //www.eurecom.fr/pubilication/2783.
Leo Breiman. Bagging predictors. Machine Learning, 24(2):123-140, 1996. ISSN 08856125. doi: 10.1007/BF00058655. URL http://www.springerlink.com/index/ 10.1007/BF00058655.
Fortinet. https://www.fortinet.com/content/dam/fortinet/assets/alliances/sb-fortinet-mcafee-solution.pdf, Last accessed on 2021-2-17.
Ilir Gashi, Bertrand Sobesto, Vladimir Stankovic, and Michel Cukier. Does malware detection improve with diverse antivirus products? an empirical study. In Friedemann Bitsch, Jérémie Guiochet, and Mohamed Kaâniche, editors, Computer Safety, Reliability, and Security, pages 94-105, Berlin, Heidelberg, 2013. Springer Berlin Heidelberg. ISBN 978-3-642-40793-2.
Mederic Hurier, Kevin Allix, Tegawende F. Bissyande, Jacques Klein, and Yves Le Traon. On the lack of consensus in anti-virus decisions: Metrics and insights on building ground truths of android malware. In Juan Caballero, Urko Zurutuza, and Ricardo J. Rodriguez, editors, Detection of Intrusions and Malware, and Vulnerability Assessment, pages 142-162, Cham, 2016. Springer International Publishing. ISBN 978-3-319-40667-1.
Robert A. Jacobs, Michael I. Jordan, Steven J. Nowlan, and Geoffrey E. Hinton. Adaptive Mixtures of Local Experts. Neural Computation, 3(1):79-87, February 1991. ISSN 0899-7667. doi: 10.1162/neco.1991.3.1.79. URL http: //www.mitpressjournals.org/doi/10.1162/ neco.1991.3.1.79.
Yongkang Jiang, Shenghong Li, and Tong Li. Em meets malicious data: A novel method for massive malware family inference. In Proceedings of the 2020 3rdInternational Conference on Big Data Technologies, ICBDT 2020, page 74-79, New York, NY, USA, 2020. Association for Computing Machinery. ISBN 9781450387859. doi: 10.1145/3422713.3422743. URL https://doi.org/10.1145/3422713.3422743.
Alex Kantchelian, Michael Carl Tschantz, Sadia Afroz, Brad Miller, Vaishaal Shankar, Rekha Bachwani, Anthony D. Joseph, and J. D. Tygar. Better malware ground truth: Techniques for weighting anti-virus vendor labels. In ACM Workshop on Artificial Intelligence and Security, 2015.
T. Kolda and B. Bader. Tensor decompositions and applications. SIAM Rev., 51: 455-500, 2009.
Ignacio Martin, Jose Alberto Hernandez, and Sergio de los Santos. Machine-learning based analysis and classification of android malware signatures. Future Generation Computer Systems, 97:295-305, 2019. ISSN 0167-739X. doi:https: //doi.org/10.1016/j.future.2019.03.006. URL https://www.sciencedirect.com/ science/article/pii/SO167739X18325159.
Aziz Mohaisen and Omar Alrawi. Av-meter: An evaluation of antivirus scans and labels. In Sven Dietrich, editor, Detection of Intrusions and Malware, and Vulnerability Assessment - 11th International Conference, DIMVA 2014, Egham, UK, July 10-11, 2014. Proceedings, volume 8550 of Lecture Notes in Computer Science, pages 112-131. Springer, 2014. doi: 10.1007/978-3-319-08509-8 _7. URL https://doi.org/10.1007/978-3-319-08509-8_7.
A. Moser, C. Kruegel, and E. Kirda. Limits of static analysis for malware detection. In Twenty-Third Annual Computer Security Applications Conference (ACSAC 2007), pages 421-430, 2007. doi: 10.1109/ACSAC.2007.21.
Edward Raff and Charles Nicholas. A Survey of Machine Learning Methods and Challenges for Windows Malware Classification. In NeurIPS 2020 Workshop: ML Retrospectives, Surveys & Meta-Analyses (ML-RSA), 2020. URL http://arxiv.org/ abs/2006.09271.
https://web.archive.org/web/20150325170122/http://www.articletrader.com/computers/softw are/k7-computing-launches-new-customer-awareness-and-brand-campaign-for-k7-totalsecurity-10.html
Marcos Sebastian, Richard Rivera, Platon Kotzias, and Juan″ Caballero. https:// github.com/malicialab/avclass/blob/master/avclass/lib/avclass_common.py, Last accessed on 2021-2-16.
Marcos Sebastian, Richard Rivera, Platon Kotzias, and Juan Caballero. Avclass: A tool for massive malware labeling. In Fabian Monrose, Marc Dacier, Gregory Blanc, and Joaquin Garcia-Alfaro, editors, Research in Attacks, Intrusions, and Defenses, pages 230-253, Cham, 2016. Springer International Publishing. ISBN 978-3-319-45719-2.
https://www.slideshare.net/JohnSeymour5/labeling-the-virus-share-malware-dataset-lessons-learned.
E. C. Spafford. Is anti-virus really dead? Computers & Security, 44:iv, 2014. ISSN 0167-4048. doi: https://doi.org/10.1016/S0167-4048(14)00082-0. URL http: //www.sciencedirect.com/science/article/pii/S0167404814000820.
Ashish Vaswani, Noam Shazeer, Niki Parmar, Jakob Uszkoreit, Llion Jones, Aidan N Gomez, Lukasz Kaiser, and Illia Polosukhin. Attention is all you need. In I. Guyon, U. V. Luxburg, S. Bengio, H. Wallach, R. Fergus, S. Vishwanathan, and R. Garnett, editors, Advances in Neural Information Processing Systems, volume 30, pages 5998-6008. Curran Associates, Inc., 2017. URL https://proceedings.neurips.cc/paper/2017/file/ 3f5ee243547dee91fbd053c1c4a845aa-Paper.pdf.
VirusTotal, . https://blog.virustotal.com/2014/02/virustotal-aegislab.html, Last accessed on 2021-2-18.
VirusTotal, . https://blog.virustotal.com/2014/11/virustotal-alyac.html, Last accessed on 2021-2-12.
VirusTotal, . https://blog.virustotal.com/2015/06/virustotal-norman.html, Last accessed on 2021-2-12.
Daniel Votipka, Seth Rabin, Kristopher Micinski, Jeffrey S Foster, and Michelle L Mazurek. An Observational Investigation of Reverse Engineers’ Process and Mental Models. In Extended Abstracts of the 2019 CHI Conference on Human Factors in Computing Systems, 2019. doi: 10.1145/3290607.3313040.
David H. Wolpert. Stacked generalization. Neural networks, 5:241-259, 1992. URL http://www.sciencedirect.com/science/article/pii/S0893608005800231.
Shuofei Zhu, Jianjun Shi, Limin Yang, Boqin Qin, Ziyi Zhang, Linhai Song, and Gang Wang. Measuring and modeling the label dynamics of online anti-malware engines. In 29th USENIXSecurity Symposium (USENIXSecurity 20), Boston, MA, August 2020. USENIX Association. URL https://www.usenix.org/conference/ usenixsecurity20/presentation/zhu.

What is claimed is:

1. A system for modeling correlation in a sourcing model, the system comprising:
a processor configured to collect voting output from plural voting sources and store the voting output in memory;
a correlation modeling module configured to:
retrieve at least two voting outputs from memory
determine correlation among at least two voting sources by measuring consensus among the at least two voting sources using an agreement metric;
determine a degree of a first-order interaction among the at least two voting sources; and
determine a degree of correlation among the at least two voting sources having a degree of first-order interaction.

2. The system of claim 1, wherein:
the correlation modeling module is configured to generate a similarity matrix representing correlation among the at least two voting sources.

3. The system of claim 2, wherein:
the correlation modeling module is configured to implement the agreement metric by dividing a number of occurrences in which a voting output from a first voting source agrees with a voting output from a second voting source by a number of occurrences in which the voting output from the first voting source and the voting output from the second voting source are present.

4. The system of claim 1, wherein:
the correlation modeling module is configured to generate a similarity matrix representing correlation among the at least two voting sources; and
the correlation modeling module is configured to generate a matrix decomposition that identifies a first-order interaction among the at least two voting sources.

5. The system of claim 4, wherein:
the correlation modeling module is configured such that the matrix decomposition generates a matrix consisting of at least one first-order interaction among the at least two voting sources.

6. The system of claim 5, wherein:
the correlation modeling module is configured such that the matrix decomposition identifies at least one first-order interaction that is stored and/or used as a vector consisting of the at least one first-order interaction from the matrix.

7. The system of claim 6, wherein:
the correlation modeling module is configured to model the similarity matrix as:
$$D = {\sum }_{i = 1}^{k} \text{triu} \left({r}_{i} {r}_{i}^{⊤} , 1\right)$$
, wherein each rᵢ represents at least one first-order interaction in the similarity matrix D.

8. The system of claim 7, wherein:
the correlation modeling module is configured to execute computer instructions that implement the following algorithm:
Require: Similarity matrix D, early stopping threshold δ
1:function RlSM-G_{REEDY}(D, δ)
2: Y₁← D, i ← 0
3: do
4: i ← i + 1
5: Find rᵢ which maximally explains Yᵢ
6: ${R}_{1} ← \text{triu} \left({r}_{1} {r}_{i}^{⊤} , 1\right)$
7: Yᵢ₌₁ ← Yᵢ - Rᵢ
8: while $\frac{\sum {R}_{i}}{\sum D} \geq δ$
9: return r₁, r₂, ...rᵢ₋₁
wherein:
Yi is the residual of triu(D,1); and
$${R}_{i} = \text{triu} \left({r}_{i} {r}_{i}^{\text{T}} , 1\right)$$
.

9. The system of claim 7, wherein:
the correlation modeling module is configured to:
generate plural similarity matrices, each similarity matrix being generated to represent correlation among at least two voting sources at different points in time over a time period; and
wherein
$$D = \left[{D}_{1} , {D}_{2} , … {D}_{\text{T}}\right]$$
.

10. The system of claim 9, wherein:
the correlation modeling module is configured to execute computer instructions that implement the following algorithm:
Require: Time-series of similarity matrices D = [D₁, D₂, ...D_{T}],
early stopping threshold δ, and penalty term λ
1:function R1SM-T(D, δ, λ)
2: Y₁ ← D, i ← 0
3: do
4: i ← i + 1
5: Initialize network F(·)
6: while F has not converged do
7: i ← 0
8: r_{i,1}, r_{i,2}, ...rᵢ,T ← F(X)
9: for t ← 1 to T do
10: ${U}_{t} ← min \left(\text{triu}\right) \left({r}_{i , t} {r}_{i , t}^{\text{T}} , 1\right) \text{-} {Y}_{i , t} , \left(0\right)$
11: ${O}_{t} ← max \left({\text{Y}}_{i , t} \text{-} \text{triu}\right) \left({r}_{i , t} {r}_{i , t}^{\text{T}} , 1\right) , \left(0\right)$
12: $l ← l + {\left‖λ {U}_{t} + {O}_{t}\right‖}_{2}$
13: Back-propagate l and run optimizer step.
14: r_{i,1.} r_{i,2,} ...r_{i,T} ← F(X)
15: for t ← 1 to T do
16: ${R}_{i , t} ← min \left(\text{triu}\right) \left({r}_{i , t} {t}_{i , t}^{\text{T}} , 1\right) , \left({Y}_{i , t}\right)$
17: Y_{i+1,t} ← Y_{i,t} - R_{i,t} ← Y_{i,t} - R_{i,t}
18: while $\frac{\sum {R}_{t}}{\sum D} \geq δ$ 19: return r_{1,} r₂, ...rᵢ₋₁
wherein:
F(·) is a deep neural network configured to optimize values in rᵢ at each iteration i;
Uₜ and Oₜ are matrices representing element-wise differences between
$$\text{triu} \left({r}_{i , t} {r}_{i , t}^{\text{T}} , 1\right) \text{and} {Y}_{i , t}$$
; and
λ = [0,1].

11. The system of claim 1, wherein the sourcing model includes:
a crowdsourcing model; or
an antivirus label decisioning model.

12. A system for modeling correlation in a sourcing model, the system comprising:
a processor configured to collect voting output from plural voting sources and store the voting output in memory;
a correlation modeling module configured to:
retrieve at least two voting outputs from memory;
determine correlation among at least two voting sources by measuring consensus among the at least two voting sources using an agreement metric;
determine a degree of a first-order interaction among the at least two voting sources; and
determine a degree of correlation among the at least two voting sources having a degree of a first-order interaction; and
wherein the processor is configured to assign a weight factor to each voting source of the at least two voting sources based on the degree of correlation attributed to their respective first-order interactions.

13. The system of claim 12, wherein:
the processor is configured to assign a weight factor value that is inversely proportional to the degree of correlation attributed to the first-order interaction.

14. A method for modeling correlation in a sourcing model, the method comprising:
retrieving at least two voting outputs from plural voting sources;
determining correlation among at least two voting sources by measuring consensus among the at least two voting sources using an agreement metric;
determining a degree of a first-order interaction among the at least two voting sources; and
determining a degree of correlation among the at least two voting sources having a degree of first-order interaction.

15. The method of claim 14, comprising:
generating a similarity matrix representing correlation among the at least two voting sources.

16. The method of claim 14, wherein:
implementing the agreement metric by dividing a number of occurrences in which a voting output from a first voting source agrees with a voting output from a second voting source by a number of occurrences in which the voting output from the first voting source and the voting output from the second voting source are present.

17. The method of claim 14, wherein:
generating a similarity matrix representing correlation among the at least two voting sources; and
generating a matrix decomposition that identifies the first-order interaction among the at least two voting sources.

18. The method of claim 17, wherein:
the matrix decomposition generates a matrix consisting of at least one first-order interaction among the at least two voting sources.

19. The method of claim 18, wherein:
the matrix decomposition identifies at least one first-order interaction that is stored and/or used as a vector consisting of the at least one first-order interaction from the matrix.

20. The method of claim 14, wherein the sourcing model includes:
a crowdsourcing model; or
an antivirus label decisioning model.
